(19) United States
(12) Patent Application Publication
(10) Pub. No.: US 2017/0212633 A1
(43) Pub. Date: Jul. 27, 2017

(54) AUTOMOTIVE CONTROL SYSTEM AND METHOD FOR OPERATING THE SAME

(71) Applicant: Samsung Electronics Co., Ltd., Gyeonggi-do (KR)

(72) Inventors: Juyeon YOU, Gyeonggi-do (KR); Jaeyeon Rho, Seoul (KR); Sangchul Yi, Seoul (KR); Sungwook Lee, Seoul (KR); Yongjun Lim, Seoul (KR); Jaemo Choi, Gyeonggi-do (KR)

(73) Assignee: Samsung Electronics Co., Ltd.

(21) Appl. No.: 15/416,761

(22) Filed: Jan. 26, 2017

(30) Foreign Application Priority Data
Jan. 26, 2016 (KR) 10-2016-0009607

(51) Int. Cl. G06F 3/041; B60K 37/02; G06F 3/0488; B60K 35/00

(52) U.S. Cl. CPC G06F 3/0416; G06F 3/0412; B60K 35/00; B60K 37/02; G06F 3/04883; B60K 2350/1028; B60K 2350/352; B60K 2350/928; B60K 2350/2026; B60K 2350/2052; B60K 2350/2013; G06F 2203/04104

(57) ABSTRACT

Disclosed is an automotive control system and a method for operating the same, the method including receiving a user input through an input device provided on a steering wheel, and controlling a display that is located in front of a driver's seat based on the user input, wherein the input device is located on one side and an opposing side of the steering wheel and is composed of a display including a touch screen.

### PRIORITY

This application claims priority under 35 U.S.C. §119(a) to a Korean Patent Application filed in the Korean Intellectual Property Office on Jan. 26, 2016 and assigned Serial No. 10-2016-0009607, the contents of which are incorporated herein by reference.

### BACKGROUND

1. Field of the Disclosure

The present disclosure relates generally to an automotive control system and a method for operating the same.

2. Description of the Related Art

With the rapid development of information and communication technology, an autonomous system has been introduced in various industry fields. In the future when the autonomous system becomes an integral part of industry and daily life, an automobile would cease to be a simple means of transportation. For example, a future automobile may be a private space in which various types of consumption can be performed. The automobile may provide a service that suits not only a driver but also a passenger of the automobile.

In a conventional automobile, a display and a user interface that is provided through the display are driver-focused. Although an automobile display has been expanded to exist in not only a cluster region of a driver's seat but also a center fascia region, there is lacking and needed in the art an automotive control system in which a driver and a passenger can independently consume and occasionally share content, in order to enhance the flexibility of the automobile user interface and, in turn, the automobile experience incurred by the users.

### SUMMARY OF THE DISCLOSURE

An aspect of the present disclosure is to address at least the above-mentioned problems and/or disadvantages and to provide at least the advantages described below.

Accordingly, an aspect of the present disclosure is to provide an automotive control system and a method for operating the same, which can enable a driver and a passenger to independently consume content and to occasionally share the content that is used by the driver and the passenger.

According to an aspect of the present disclosure, an automotive control system includes a display located in front of a driver's seat of an automobile, an input device provided on a steering wheel, and a control unit electrically connected to the display and the input device, wherein the control unit controls the display based on a user input through the input device, and wherein the input device is located on one side of the steering wheel and an opposite side of the one side of the steering wheel and is composed of a display including a touch screen.

According to another aspect of the present disclosure, a method for operating an automotive control system includes receiving a user input through an input device provided on a steering wheel of an automobile, and controlling a display that is located in front of the driver's seat based on the user input, wherein the input device is located on one side of a steering wheel and on an opposite side of the one side of the steering wheel and is composed of a display including a touch screen.

According to another aspect of the present disclosure, disclosed is a non-transitory computer readable recording medium having recorded thereon instructions that cause at least one control unit to perform a method for operating an automotive control system having a display located in front of a driver's seat, comprising receiving a user input through an input device provided on a steering wheel of an automobile, and controlling a display that is located in front of the driver's seat based on the user input, wherein the input device is located on one side of a steering wheel and on an opposite side of the one side of the steering wheel and is composed of a display including a touch screen.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates the configuration of an automotive control system according to embodiments of the present disclosure;

FIG. 2 illustrates the interior of an automobile to which an automotive control system according to embodiments of the present disclosure is applied;

FIG. 3 illustrates the interior of an automobile to which an automotive control system according to embodiments of the present disclosure is applied;

FIG. 4 illustrates a method for operating an input device according to an embodiment of the present disclosure;

FIGS. 5A, 5B and 5C illustrate a method for operating an input device according to embodiments of the present disclosure;

FIG. 6 illustrates an auxiliary input device according to an embodiment of the present disclosure;

FIG. 7 illustrates the exterior of an automobile to which an automotive control system according to embodiments of the present disclosure is applied;

FIG. 8 illustrates a method for operating an automotive control system according to embodiments of the present disclosure;

FIGS. 9A and 9B illustrate a display screen according to an embodiment of the present disclosure;

FIG. 10 illustrates a part of a display screen according to an embodiment of the present disclosure;

FIG. 11 illustrates an app market for a vehicle according to an embodiment of the present disclosure;

FIG. 12 illustrates a display screen according to an embodiment of the present disclosure;

FIG. 13 illustrates a display screen during forward travel according to an embodiment of the present disclosure;

FIG. 14 illustrates a display screen during reverse travel according to an embodiment of the present disclosure;

FIG. 15 illustrates a display screen during normal traveling according to an embodiment of the present disclosure;

FIG. 16 illustrates a display screen during normal traveling according to an embodiment of the present disclosure;

FIG. 17 illustrates a display screen during normal traveling according to an embodiment of the present disclosure; and

FIG. 18 illustrates a quick function according to an embodiment of the present disclosure.

### DETAILED DESCRIPTION OF EMBODIMENTS OF THE DISCLOSURE

Hereinafter, embodiments of the present disclosure will be described with reference to the accompanying drawings. However, it should be understood that the present disclosure is not limited to the specific embodiments described hereinafter, but includes various modifications, equivalents, and/or alternatives to the embodiments of the present disclosure. In describing the drawings, similar reference numerals may be used for similar constituent elements.

A singular expression may include a plural expression unless specially described. In the description, the expressions “A or B” and “at least one of A and/or B” include all possible combinations of A and B enumerated together.

The terms “first” and “second” used in embodiments may describe various constituent elements, but should not limit the corresponding constituent elements. For example, when it is described that a first element is “connected” or “coupled” to a second element, the first element may be “directly connected” to the second element or “connected” through another element, such as a third element.

In the present disclosure, the expression “configured to” may be interchangeably used with, in hardware or software, “suitable to”, “capable of”, “changed to”, “made to”, “able to”, or “designed to”. In a situation, the expression “device configured to” may indicate that the device can operate together with another device or components. For example, the phrase “processor configured (or set) to perform A, B, and C” may indicate a dedicated processor for performing the corresponding operation, or a general-purpose processor that can perform the corresponding operations.

The term “module” used in the present disclosure may refer to a unit including one or more combinations of hardware, software, and firmware. The “module” may be interchangeably used with a “unit,” “logic,” “logical block,” “component,” or “circuit,” for example. The “module” may be a minimum unit of a component formed as one body or a part thereof, and for performing one or more functions or a part thereof. The “module” may be implemented mechanically or electronically. For example, the “module” according to an embodiment of the present disclosure may include at least one of an application-specific integrated circuit (ASIC) chip, a field-programmable gate array (FPGA), and a programmable-logic device for performing certain operations which have been known or are to be developed in the future.

Examples of computer-readable media include magnetic media, such as hard disks, floppy disks, and magnetic tape, optical media such as compact disc read only memory (CD-ROM) disks and a digital versatile disc (DVD), magneto-optical media, such as floptical disks, and hardware devices that are specially configured to store and perform program instructions, such as read-only memory (ROM), random access memory (RAM), and flash memory. Examples of program instructions include machine code instructions created by assembly languages, such as a compiler, and code instructions created by a high-level programming language executable in computers using an interpreter. The described hardware devices may be configured to perform as one or more software modules in order to perform the operations and methods described herein, or vice versa.

Modules or programming modules according to the embodiments of the present disclosure may include one or more components, remove part of the components, or include new components. The operations performed by modules, programming modules, or the other components, according to the present disclosure, may be executed in serial, parallel, repetitive or heuristic fashion. Part of the operations can be executed in any other order, skipped, or executed with additional operations.

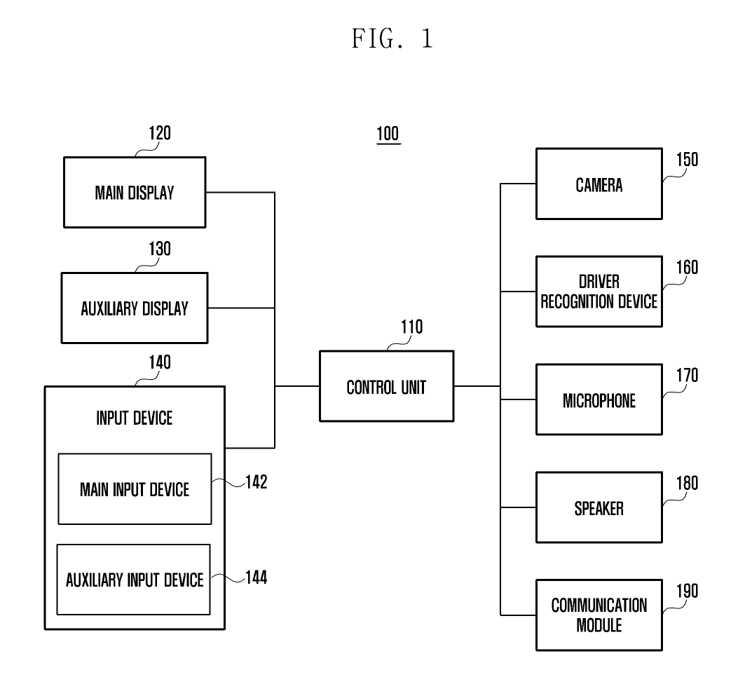

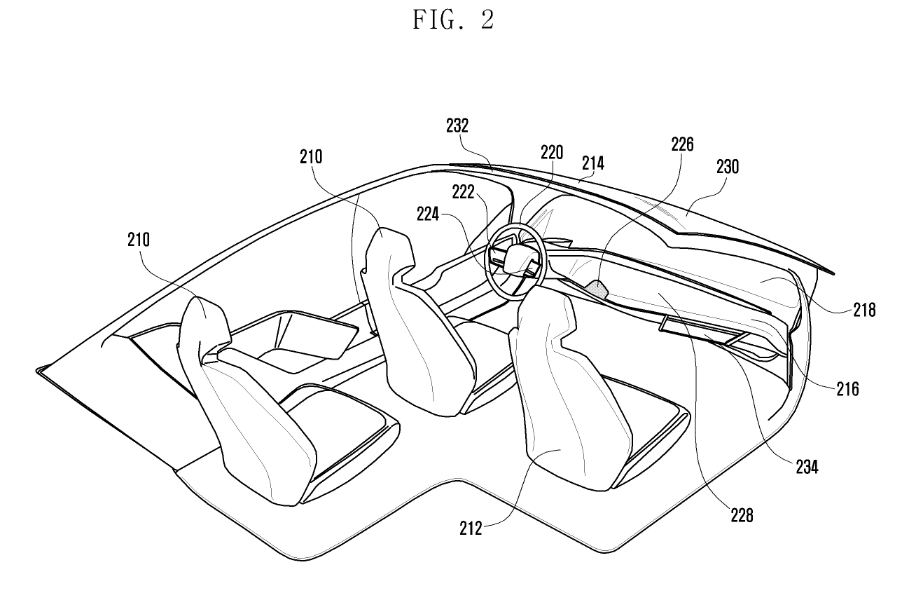

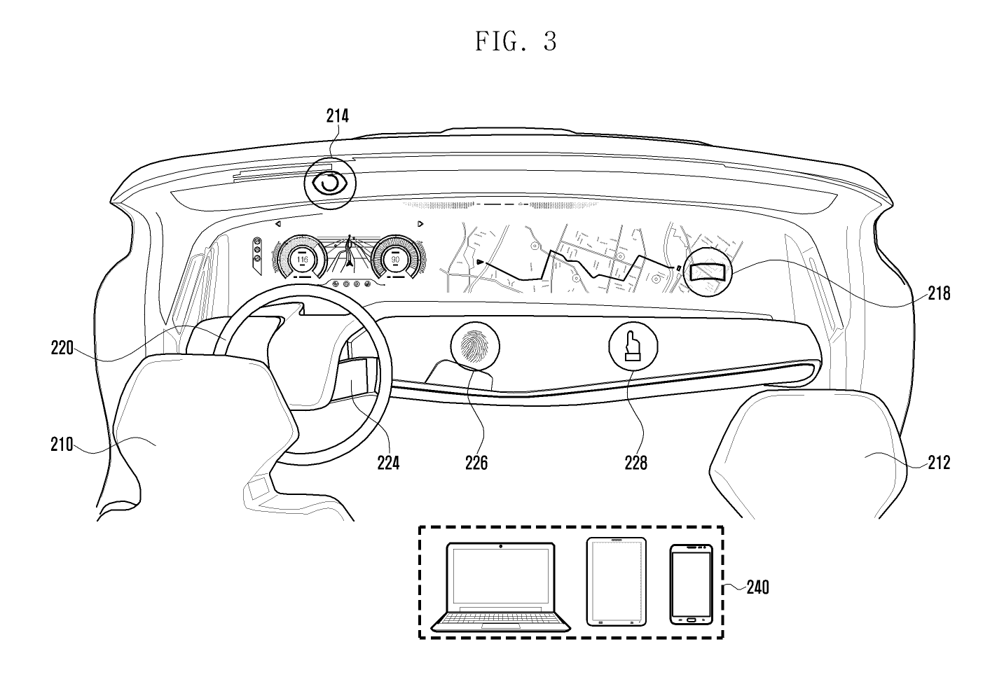

FIG. 1 illustrates the configuration of an automotive control system according to embodiments of the present disclosure. FIG. 2 illustrates the interior of an automobile to which an automotive control system according to embodiments of the present disclosure is applied, and FIG. 3 illustrates the interior of an automobile to which an automotive control system according to embodiments of the present disclosure is applied.

Referring to FIG. 1, an automotive control system may include a control unit 110, a main display 120, an auxiliary display 130, an input device 140, a camera 150, a driver recognition device 160, a microphone 170, a speaker 180, and a communication module 190.

The control unit 110 may control plural hardware or software constituent elements connected to the control unit 110 and perform various types of data processes and operations through driving of the operating system or applications. For example, the control unit 110 may be implemented by a system on chip (SoC). According to an embodiment, the control unit 110 may include a graphic processing unit (GPU) and/or an image signal processor. The control unit 110 may load a command or data that is received from at least one of other constituent elements, such as a nonvolatile memory, in a volatile memory, and store the resultant data in a nonvolatile memory. The control unit 110 may include one or more of a central processing unit (CPU), an application processor, and a communication processor (CP) and may control at least one constituent element of the automotive control system and/or perform a communication-related operation or data process.

According to an embodiment, the control unit 110 may provide an intelligent environment based on driver data that is pre-stored in the memory or driver data that is received from an external device through the communication module 190. For example, the intelligent environment may be provided so that a driver can execute a specific application even during traveling and perform user confirmation according to a push notification. In order to provide the intelligent environment, the control unit may include a voice recognition system that can recognize driver's voice as a natural language and a voice guide system that can provide a feedback according to the push notification or a driver's request.

The main display 120 may include a liquid crystal display (LCD), a light emitting diode (LED) display, an organic light emitting diode (OLED) display, a micro electro-mechanical system (MEMS) display, or an electronic paper display. The main display 120 may display various types of content, such as a text, image, video, icon, and/or symbol, to a user. The main display 120 may include a touch screen, which can receive a touch, gesture, approach, or hovering input using an electronic pen or a part of a user's body.

As illustrated in FIGS. 2 and 3, a main display 218 may be a single display that is mounted on a dashboard 216 and is extended from a front side of a driver's seat 210 to a front side of a passenger seat 212. For example, the main display 218 may be a wide curved display that is connected from in front of the driver's seat 210 to in front of the front passenger seat 212.

Under the control of the control unit 110, the main display 218 may provide a user interface so that a customized screen according to a driver can be provided and a driver and a passenger can share or individually use content, may divide a display region into a plurality of regions, and provide a user interface in each divided region or in the entire region, and may display a front (or rear) screen of an automobile as the entire screen when the automobile travels to heighten user convenience.

According to embodiments, the dashboard 216 may be located from the front side of the driver's seat 210 to the front of the passenger seat 212, and between the driver's seat 210 and windshield 230. For example, the dashboard 216 has an instrument cluster mounted thereon, and the main display 218 may be mounted on the dashboard 216. The dashboard 216 may be integrally formed with the main display 218. For example, the main display 218 may be configured to cover the entire surface of the dashboard 216. Although it is described that the main display 218 is mounted on the dashboard 216 in the description, the assembly types of the dashboard 216 and the main display 218 may be variously changed.

The auxiliary display 130 may display an image on the entire or a partial region of the windshield 230. For example, the auxiliary display 130 may display an image on the windshield 230 that is located in front of the driver's seat 210, may provide a user interface in accordance with a road guide application under the control of the control unit 110, and may provide a quick execution application that is predetermined by a driver or a push notification screen.

According to an embodiment, the auxiliary display 214 may include a head-up display, a hologram display, or a transparent display. The head-up display may display an image on a partial or entire region of the windshield 230 using light reflection. The hologram display may display a stereoscopic image in the air using light interference. The hologram display may provide an augmented reality (AR) navigation or a vehicle status notification service under the control of the controller.

The head-up display and the hologram display may include a projector that displays an image through projection of light onto the windshield 230 of the vehicle. For example, the projector may be mounted on an upper surface of the dashboard. According to an embodiment, the auxiliary display 214 may be composed of a transparent display that is included in the windshield 230 of the automobile and may be provided in the entire or partial region of the windshield 230 of the automobile.

The input device 140 may include a touch panel, a pen sensor, or an ultrasonic input device 140, may use at least one of capacitive, resistive, infrared, and ultrasonic types, and may further include a control circuit and a tactile layer to provide a tactile reaction to a user. The pen sensor may be a part of the touch panel, or may include a separate recognition sheet. The key may include a physical button, an optical key, or a keypad. The ultrasonic input device 140 may sense ultrasonic waves generated from an input tool through the microphone, and confirm data that corresponds to the sensed ultrasonic waves.

According to an embodiment, the input device may include a main input device 142 for receiving a user input from a driver, and an auxiliary input device 144 for receiving a user input from a passenger.

As illustrated in FIGS. 2 and 3, the main input device steering wheel may include a first main input device 222 that is provided on one side of the steering wheel and a second main input device 224 that is provided on the opposite side of the steering wheel. The first main input device 222 may be composed of a display that includes a touch screen, and may provide an application list from the current automotive control system and a screen selection interface for selecting a region in which an application execution screen is to be provided. The second main input device 224 may be composed of a display that includes a touch screen in the same manner as the first main input device 222, and may provide a control interface for controlling in detail the user interface in a user selection region that is received through the first main input device 222. The locations of the first and second main input devices 222 and 224 may be swapped with each other.

According to an embodiment, the auxiliary input device 228 may be provided on at least one of the center of the dashboard 216, the dashboard 216 in front of the passenger seat 212, a door handle, an arm rest of a backseat, and a rear surface of a head rest provided in the driver's seat 210 and the passenger seat 212. For example, the auxiliary input device 228 may include a touch pad provided in the center of the dashboard 216 or a tablet pad 234 mounted on the dashboard 216 in front of the passenger seat 212.

The auxiliary input device 228 may provide a user interface for controlling the remaining region that is not selected by the driver to the passenger through the main input devices 222 and 224 in the main display 218. For example, when the driver consumes content using the entire region of the main display 218 or drives the automobile, the control of the main display 218 through the auxiliary input device 228 may be restricted. When the driver consumes content using only a partial region of the main display 218, the passenger may control the remaining region of the main display 218 through the auxiliary input device 228.

The camera 150 may capture a still image or a moving image and may include one or more cameras provided on an outside of the automobile to capture an image of the front or rear side of the automobile. For example, the camera 150 may include a wide-angle lens for capturing an image not only in the front/rear of the automobile but also on the side of the automobile.

The driver recognition device 160 may sense motion or bio information of the driver sitting in the driver's seat 210, and convert the measured or sensed information into an electrical signal. The driver recognition device 160 may include a grip sensor, a proximity sensor, a fingerprint recognition sensor, an iris recognition sensor, an e-nose sensor, an electromyography (EMG) sensor, an electroencephalogram (EEG) sensor, and electrocardiogram (ECG) sensor, and/or an infrared (IR) sensor. The driver recognition device 160 may further include a control circuit for controlling at least one sensor configured in the driver recognition device.

As illustrated in FIGS. 2 and 3, the fingerprint recognition sensor 226 may be mounted on the dashboard 216 that is adjacent to the driver's seat 210, and may be included in a user operation button for starting the automobile. For example, the fingerprint recognition sensor 226 may scan user's fingerprint information while the driver presses the user operation button to start the automobile. The iris recognition sensor (or face recognition sensor) 232 may be mounted on a ceiling in front of the driver's seat 210 and may scan user's iris or face information in response to user's pressing of the user operation button to start the automobile.

The automotive control system according to an embodiment may include an audio module having a microphone 170 and a speaker 180. For example, the audio module may convert sound and an electrical signal in a bidirectional manner, and may further include a control circuit that controls sound information that is input through the microphone 170 or output through the speaker 180.

The communication module 190 may set communication between the automotive control signal and an external device and/or a server. For example, the communication module 190 may communicate with the external device 240 or the server through connection to a network through wireless communication. The external device 240 may include at least one of a smart TV, a smart phone, a tablet PC, a mobile phone, a video phone, an e-book reader, a desk-top PC, a laptop personal computer (PC), a net-book computer, a workstation, a personal data assistant (PDA), a portable multimedia player (PMP), and MP3 player, a camera, or a wearable device.

According to an embodiment, the external device 240 may be the same as or different from the automotive control system according to the present disclosure. All or parts of operations that are executed in the automotive control system may be executed in another automotive control system, the external device 240, or a server. According to an embodiment, in the case of performing an function or service automatically or in accordance with a request in the automotive control system, the automotive control system may request another device, such as the external device 240, server, or another automotive control system, to perform at least a partial function related to the function or service instead of executing the function or service by itself or in addition to execution of the function or service by itself.

The external device 240, the server, or another automotive control system may execute the requested function or the additional function and then transfer the result of the execution to the automotive control system, which may provide the requested function or service by processing the received result as it is or additionally. For this, the automotive control system may use clouding computing, distributed computing, or client-server computing technology.

According to an embodiment, the communication module 190 may include a cellular module, a wireless fidelity (WiFi) module, a Bluetooth module, a global navigation satellite system (GNSS) module, a near field communication (NFC) module, and a radio frequency (RF) module. The cellular module may provide voice call, video call, text service, or Internet service through a communication network. The cellular module may perform discrimination and authentication of the automotive control system in the communication network using a subscriber identification module (SIM) card. The cellular module may perform at least a part of the function by the control unit 110, and may include a communication control unit (CP) 110. At least two of the cellular module, the WiFi module, the Bluetooth module, the GNSS module, and the NFC module may be included in one integrated chip (IC) or an IC package. The RF module may transmit and receive an RF signal and may include a transceiver, a power amp module (PAM), a frequency filter, a low noise amplifier (LNA), and an antenna.

According to another embodiment, at least one of the cellular module, the WiFi module, the Bluetooth module, the GNSS module, and the NFC module may transmit and receive the RF signal through a separate RF module. The SIM card may include a card or an embedded SIM, and may include inherent identification information, such as integrated circuit card identifier (ICCID) or subscriber information, such as international mobile subscriber identity (IMSI).

The wireless communication may include cellular communication that uses at least one of long term evolution (LTE), LTE advanced (LTE-A), code division multiple access (CDMA), universal mobile telecommunications system (UMTS), wireless broadband (WiBro), and global system for mobile communications (GSM). According to an embodiment, the wireless communication may include short-range communication, such as at least one of WiFi, Bluetooth®, Bluetooth low energy (BLE), Zigbee®, near field communication (NFC), magnetic secure transmission, radio frequency (RF), and body area network (BAN). The wireless communication may include GNSS such as global positioning system (GPS), global navigation satellite system (Glonass), Beidou navigation satellite system (Beidou), or Galileo, the European global satellite-based navigation system.

The memory may include a volatile memory and/or a nonvolatile memory. The memory may store commands or data related to at least one constituent element of the automotive control system. According to an embodiment, the memory may store software and/or a program which may include a kernel, middleware, an application programming interface, and/or an application program (hereinafter, “application” or “app”). At least a part of the kernel, the middleware, or the API may be called an operating system. The kernel may control or manage system resources, such as bus, control unit 110, and memory, that are used to execute operations or functions implemented in other programs, and may provide an interface that can control or manage the system resources by accessing the individual constituent elements of the automotive control system in the middleware, the API, or the application program.

The middleware may perform a relay operation so that the API or the application can communicate with the kernel to send or receive data. The middleware may process one or more task requests that are received from the application in accordance with their priorities. For example, the middleware may give a priority for using the system resource of the automotive control system to at least one of applications, and process the one or more task requests. The API is for an application to control functions that are provided from the kernel or the middleware, and may include at least one interface or command for file control, window control, video processing, or text control. The input/output interface may transfer a command or data that is input from the user or another external device to another constituent element(s) of the automotive control system, or output the command or data that is received from another constituent element(s) of the automotive control system to the user or another external device.

The following are aspects according to embodiments of the present disclosure, as described above. A method for operating an automotive control system may include receiving a user input through an input device provided on a steering wheel, and controlling a display that is located in front of a driver's seat based on the user input, wherein the input device is located on one side and the other side of the steering wheel and is composed of a display including a touch screen.

The method may further include identifying a driver through a driver recognition device, transmitting the identified driver information to an external device through a communication module; receiving driver data for the driver from the external device, and providing a user interface based on the received driver data through the display.

The user interface based on the driver data may include at least one of a road guide service to a destination according to a schedule of the driver, a surroundings guide service, and a user interface of at least one application that is preset by the driver.

The method may further include changing settings of a display layout and a background screen based on the identified driver information, and providing a user interface included in at least one application that is preset by the driver.

The method may further include connecting to an application market of the external device through a communication module based on the user input, and downloading and installing a specific application that is from the application market in a memory based on a user input for a screen that is provided by the application market.

The method may further include receiving a first user input through a first main input device provided on one side of the steering wheel, selecting a region of the display on which the user interface is to be provided in response to the first user input, and executing the application in response to a second user input through the first main input device and providing the user interface on the selected region.

The method may further include receiving a third user input through a second main input device provided on the other side of the steering wheel, and controlling particulars of the user interface that is provided on the selected region in response to the third user input.

The method may further include displaying a front screen through the display if a gear of the automobile is shifted to perform forward travel, wherein the front screen includes a dead zone image that is hidden by a dashboard and a bonnet from a viewing angle of a driver.

The method may further include setting the dead zone image to be successively connected to a front visual field that is viewed at the viewing angle of the driver.

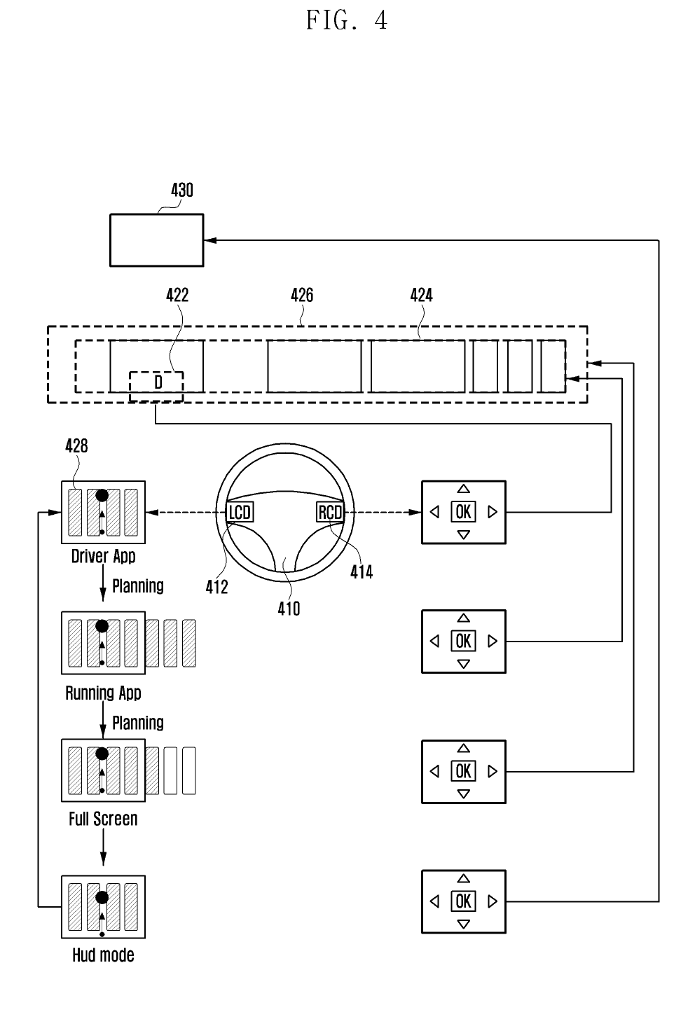

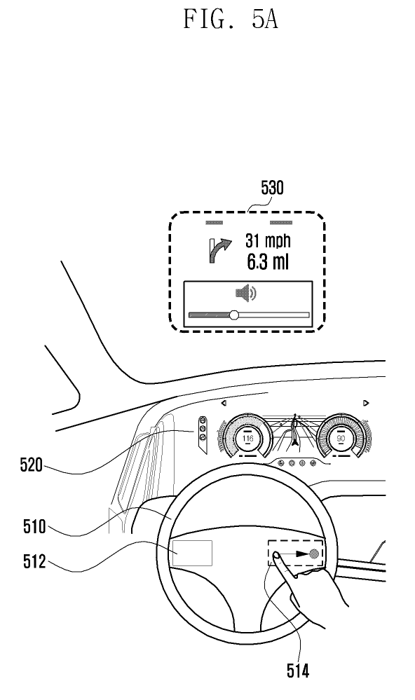

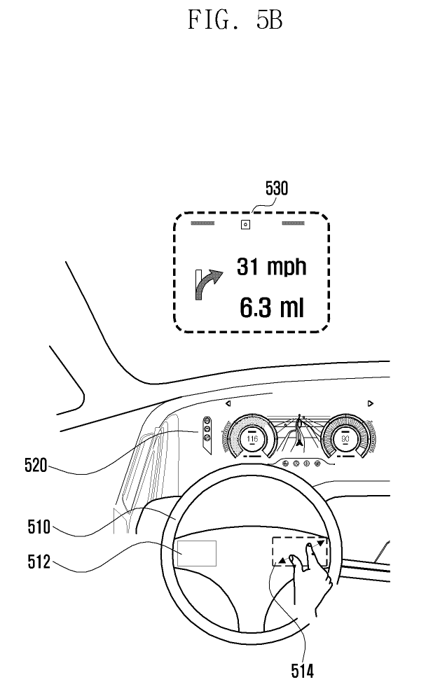

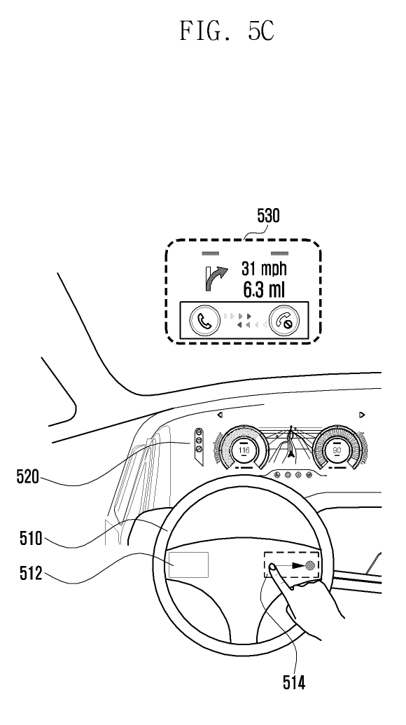

FIG. 4 illustrates a method for operating an input device according to an embodiment of the present disclosure, and FIGS. 5A, 5B and 5C illustrate a method for operating an input device according to embodiments of the present disclosure.

As illustrated in FIG. 4, a main display 426 may be divided into one or more regions to provide a user interface included in an application. For example, the main display 426 may be divided into first to third regions 422, 424, and 426. The first region 422 is provided in front of a driver's seat to display essential information that is required for driving, such as speed, fuel or energy information, and vehicle status. The second region 424 is spread from the front side of the driver's seat to the front of the passenger seat, and may provide a plurality of user interfaces through simultaneous execution of at least one application. The third region 426 may be the entire screen, that is, a full screen region, of the main display 426. For example, the third region 426 may provide one user interface that is provided by a single application in a full screen manner under the control of the control unit 110.

The control unit 110 receives a user input through a main input device provided on a steering wheel 410, and provides a user interface in the entire or partial region of a main display 426 based on the received user input, or provides a user interface in an auxiliary display 430. For example, a first main input device 412 may be provided on one side (left side) of the steering wheel 410 and may provide an application list 428 from the current automotive control system and a screen selection interface for selecting a region in which an application execution screen is to be provided. For example, the first main input device 412 may select a region, in which the user interface is to be provided, of the auxiliary display 430 and the main display 426 through the first user input. The first user input may include an operation to swipe the touch screen of the first main input device 412 in a vertical direction. Alternatively, the first main input device 412 may change the region for providing an application execution screen in response to the user's swipe operation.

As shown in FIG. 4, an application execution list that can be executed with respect to the first region 422 is first displayed on the first main input device 412, and if a user inputs the first user input, such as a swipe operation, an application execution list that can be executed with respect to the second region 424 is displayed on the first main input device 412. If the user then re-inputs the first user input, an application execution list that can be executed with respect to the third region 426 is displayed on the first main input device 412, and then if the user re-inputs the first user input, an application list that can be executed with respect to the auxiliary display 430 is displayed on the first main input device 412.

According to an embodiment, the control unit 110 may execute an application through reception of the second user input after receiving the first user input, and provide a user interface included in the application in the selected region. For example, the second user input may include an operation for touch or touch and drag of a specific icon of an application list that is being displayed on the first main input device 412. The control unit 110 may receive the second user input for the user to perform touch and drag of the specific application icon while the application list that can be executed with respect to the third region 426 is displayed on the first main input device 412. The control unit 110 may execute the specific application in response to the second user input, and provide the user interface included in the specific application on the third region 426.

According to an embodiment, the control unit 110 may control, in detail, the user interface that is provided from the main display 426 or the auxiliary display 430 through reception of the third user input through the second main input device 414 after receiving the second user input. For example, the second main input device 414 may provide a control interface that includes movement in up, down, left, and right directions and confirmation or cancelation in order to operate the user interface that is provided in the specific region.

As illustrated in FIG. 5A, the control unit 110 may control audio function based on the user input through the second main input device 514. For example, the control unit 110 may provide a user interface for adjusting audio volume through the auxiliary display 530, and receive a user input for adjusting the audio volume through the second main input device 514. The user may adjust the audio volume through a drag input in the left or right direction after performing a touch input with respect to the specific point of the second main input device 514. For example, if the user performs a drag input in one direction through the second main input device 514, the control unit 110 may increase the audio volume, whereas if the user performs a drag input in a direction opposite to the one direction through the second main input device, the control unit 110 may decrease the audio volume. According to embodiments, the control unit 110 may adjust the temperature and the fan speed of the temperature control unit in addition to the audio volume adjustment based on the user input through the second main input device 514.

According to embodiments, the control unit 110 may adjust the size of the user interface that is provided through the main display 510 or the auxiliary display 530, or enlarge or reduce a specific region based on the user input through the second main input device 514. The user input for adjusting the size of the user interface or for enlarging or reducing the specific region may include narrowing or widening a gap between two fingers with respect to the second main input device 514. For example, as illustrated in FIG. 5B, if the user performs a touch input to widen the gap between two fingers through the second main input device 514, the control unit 110 may enlarge the size of the user interface that is provided in the main display 510 or the auxiliary display 530, or may enlarge the specific region. If the user performs a touch input to narrow the gap between two fingers through the second main input device 514, the control unit 110 may reduce the size of the user interface that is provided in the main display 510 or the auxiliary display 530, or may reduce the specific region.

According to embodiments, the control unit 110 may provide a push notification in the first region of the main display 520 or the auxiliary display 530. For example, as illustrated in FIG. 5C, if a phone call is received, the control unit 110 may request user confirmation with respect to call reception through the push notification, and may provide the push notification through the auxiliary display 530 and receive the user confirmation through the second main input device 514. The user may determine whether to confirm the push notification through drag input in the left or right direction after performing a touch input with respect to a specific point of the second user main input device. For example, if the user performs a drag input in one direction through the second main input device 514, the control unit 110 may receive the phone call, whereas if the user performs a drag input in the other direction through the second main input device 514, the control unit 110 may reject the received phone call. The push notification may be provided not only visually as in the above-described example but also vocally through the speaker. For example, if a phone call is received, the control unit 110 may output a voice message “You have a call from an opposite party A”.

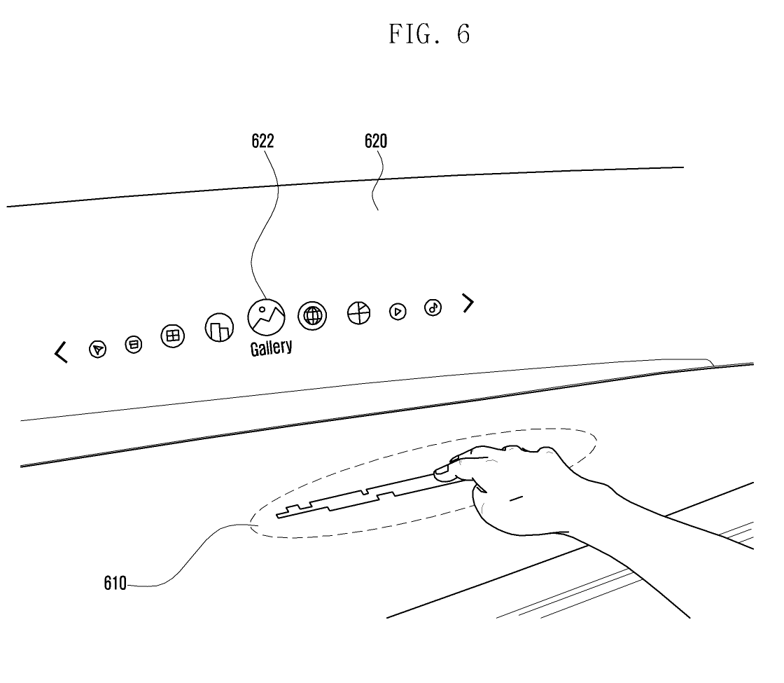

FIG. 6 illustrates an auxiliary input device according to an embodiment of the present disclosure.

As illustrated in FIG. 6, an auxiliary input device 610 may be provided in the center of a dashboard. For example, the auxiliary input device 610 may be configured as a touch control pad to select/execute a user interface, such as an icon 622 that is displayed on a region for which an authority is given from a driver to a passenger through the main input device. For example, when the driver consumes content using only a partial region of the main display 620, the control unit 110 may control the remaining region of the main display based on a user input by the passenger through the auxiliary input device 610.

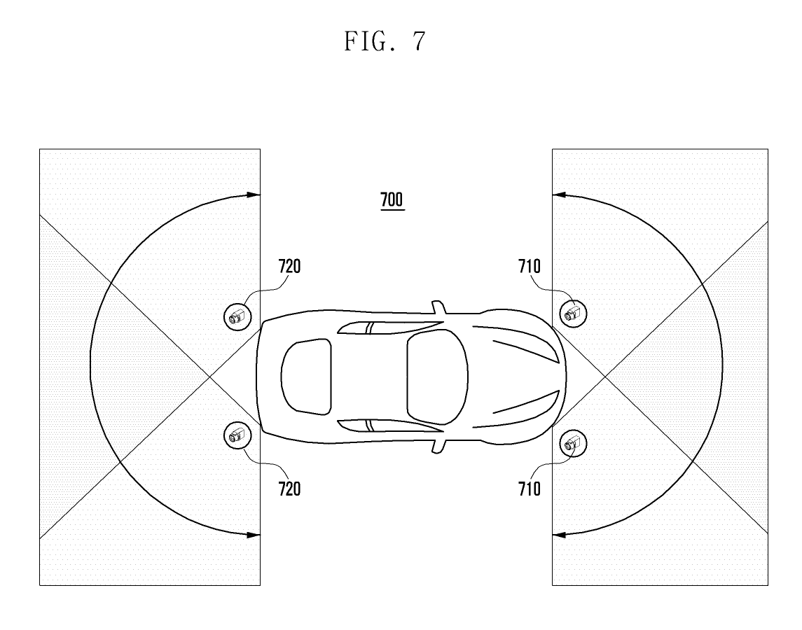

FIG. 7 illustrates the exterior of an automobile to which an automotive control system according to embodiments of the present disclosure is applied.

As illustrated in FIG. 7, one or more cameras may be provided on an outside of an automobile 700. For example, the camera may include at least one front camera 710 for capturing an image of the front side of the automobile 700 and at least one rear camera 720 for capturing an image of the rear side of the automobile 700. The front camera 710 may be provided at both ends of a front bumper of the automobile 700, and the rear camera 720 may be provided at both ends of a rear bumper of the automobile 700. In the automotive control system according to the present disclosure, the number of cameras and the locations thereof may be diversely changed.

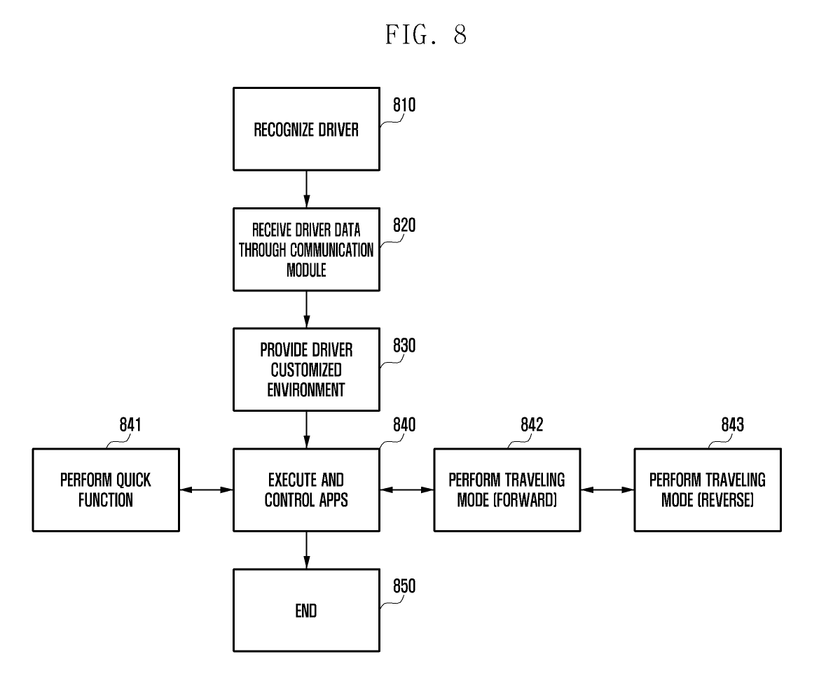

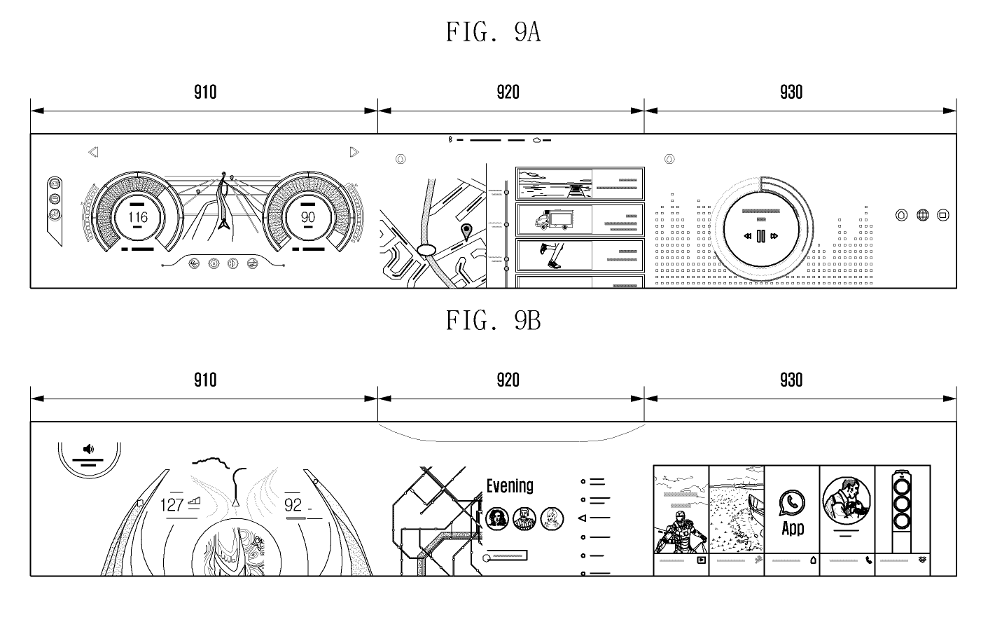

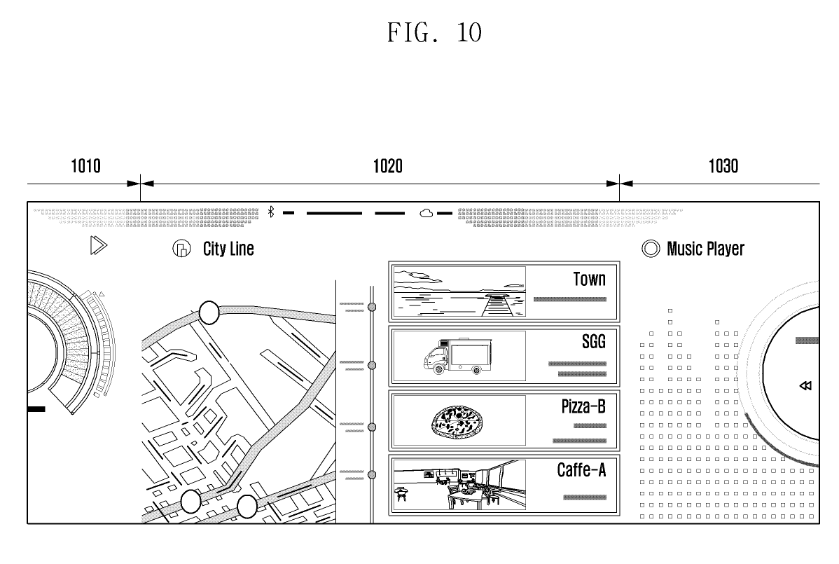

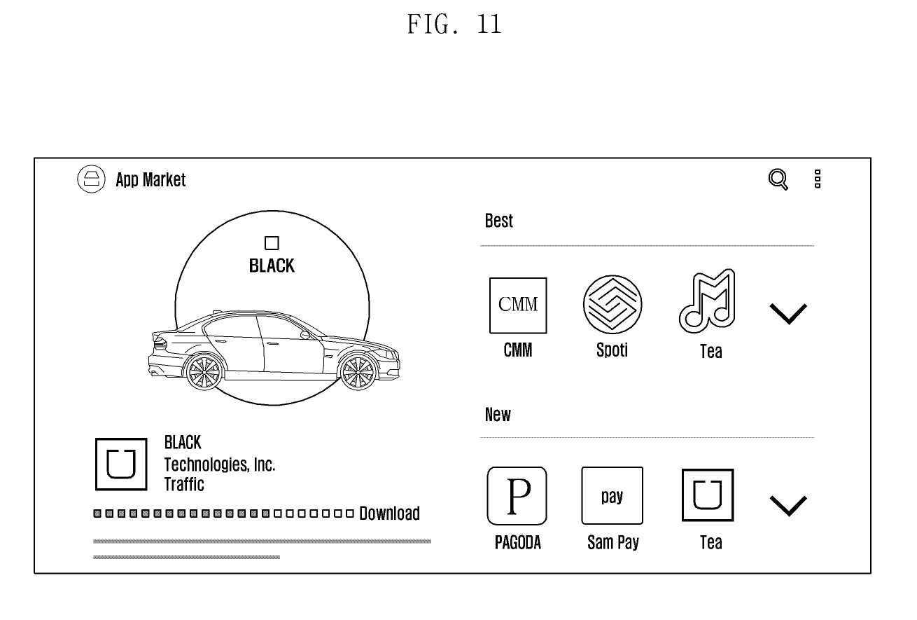

FIG. 8 illustrates a method for operating an automotive control system according to embodiments of the present disclosure. FIGS. 9A and 9B illustrate a display screen according to an embodiment of the present disclosure, and FIG. 10 illustrates a part of a display screen according to an embodiment of the present disclosure. FIG. 11 illustrates an app market for a vehicle according to an embodiment of the present disclosure.

Referring to FIG. 8, in step 810, the control unit 110 may recognize a driver and a passenger through a driver recognition device. For example, the control unit 110 may sense whether a user input is generated with respect to a start button that is provided on a dashboard. If the user input is generated with respect to the start button, the control unit 110 may scan the user's fingerprint and recognize the driver through analysis of the scanned fingerprint. According to another embodiment, if the user input is generated with respect to the start button, the control unit 110 may scan the iris or face of the user who is in the driver's seat using an iris recognition sensor (or face recognition sensor), and recognize the driver through analysis of the scanned iris or face. According to another embodiment, the control unit 110 may provide a user interface for requesting a passenger's authentication through the main display 620 to request a user authentication from the passenger. For example, the user authentication for the passenger may include an iris recognition method through an auxiliary input device 610 and a passenger identification method by scanning the iris or face of the user who is in the passenger seat and analyzing the scanned iris or face).

In step 820, the control unit 110 may transmit driver information that is recognized through the communication module 190 to an external device, such as a server, and receive driver data for the driver from the external device. For example, the driver data may include driver's schedule information or preferable peripheral information.

In step 830, the control unit 110 may provide a driver customized environment according to the recognized driver. For example, FIG. 9A illustrates a first driver customized environment that is predetermined for a driver A and is provided through the main display, and FIG. 9B illustrates a second driver customized environment that is predetermined for a driver B and is provided through the main display.

As illustrated in FIGS. 9A and 9B, the controller 110 may provide a layout of the main display and a background screen predetermined by the driver in accordance with the driver, may provide a screen that is executed on the main display by automatically executing at least one application predetermined by the driver, and may divide the main display into a driver region 910, a center region 920, and a passenger region 930 based on the user setting.

According to an embodiment, the control unit 110 may enable the main display to provide an intelligent environment based on the driver data that is received from the outside through the communication module 190. For example, as illustrated in FIG. 10, the control unit 110 may provide a road guide service to the destination in accordance with the driver's schedule. The control unit 110 may recognize the destination to which the driver should currently move through comparison between the current time and the driver's schedule, and then vocally guide the user schedule to the user through the audio module, or provide the user's schedule as an image through the main display. Referring to FIG. 10, basic information, such as speed and remaining fuel or energy, that is required for driving and a road guide application screen are provided on the driver's region 1010 of the main display, a daily schedule of the driver is provided as a list in the center region 1020 of the main display, and a music player screen is provided on a passenger region 1030 of the main display. As another example, the control unit 110 may automatically execute a peripheral guide service of a category predetermined by the driver or a user interface of at least one application predetermined by the driver, by guiding only the peripheral information predetermined by the driver, such as a large discount store, a hospital, a gas station, a restaurant, a café, a sports center, a park, and a restroom.

Returning to FIG. 8, in step 840, the control unit 110 may download a service that comports with preferences of the driver or the passenger through connection to an app market for an automobile through the communication module 190, and apply the downloaded service to the automotive control system. For example, as illustrated in FIG. 11, the automotive control system may be configured as an open platform that can connect to an app market for an automobile and download and install various applications in a memory. For example, the control unit 110 may change layouts of the main display and the auxiliary display and the background screen through installation of various applications required by the driver and the passenger, and may consume content that is provided through the main display and the auxiliary display to suit the respective preferences.

In step 841, the control unit 110 may provide a quick function based on the user input through the first main input device. For example, the quick function is required when the driver is driving the automobile, and may easily execute an application that is necessary to be quickly executed or is provided as a favorite.

In steps 842 and 843, if a gear of the automobile is shifted into drive for forward travel or into reverse for rearward travel, the control unit 110 may provide minimum information that is required for driving in a specific region of the main display and provide remaining information in the remaining region of the main display. For example, when the automobile is traveling, the control unit 110 may set limitations in the control operation of the main display through the auxiliary input device, or may not control the main display region in front of the driver's seat.

In step 850, the control unit 110 may end the operation of the automotive control system as the power of the automobile is turned off.

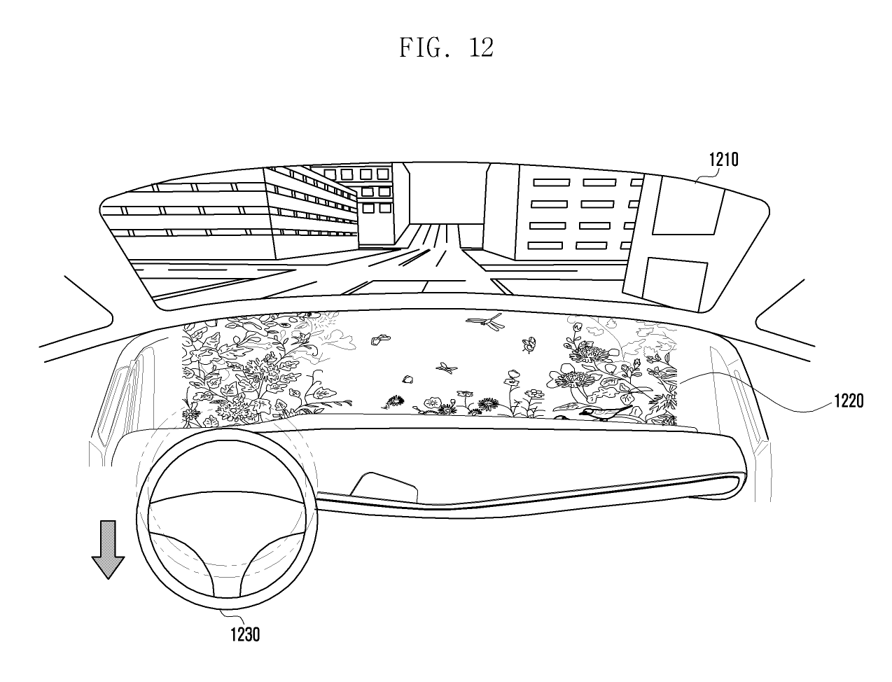

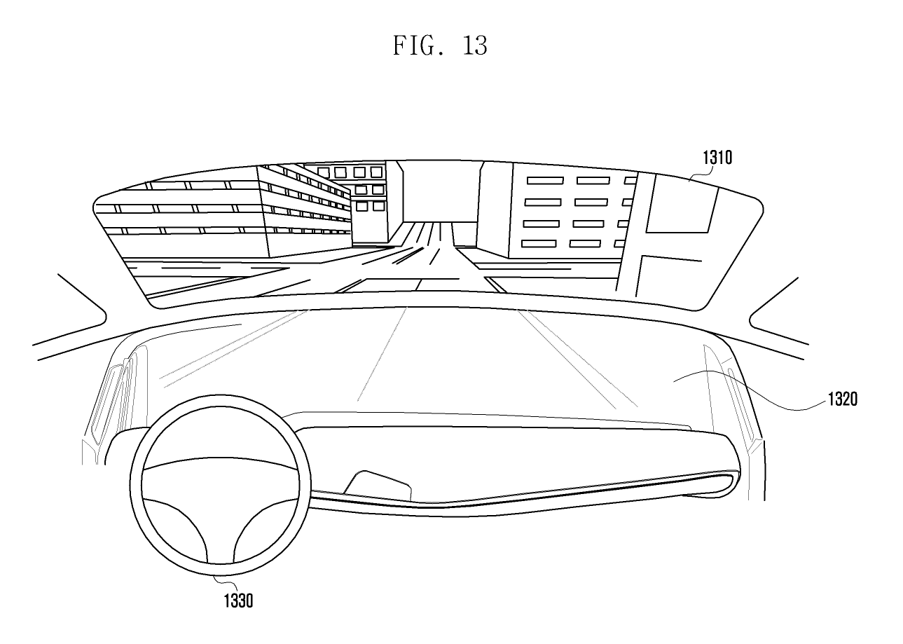

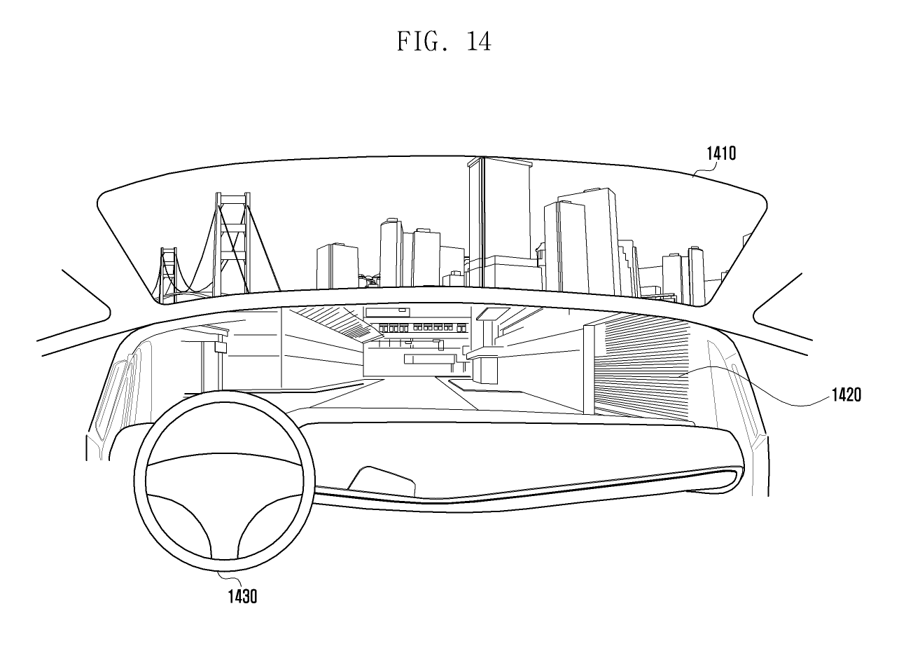

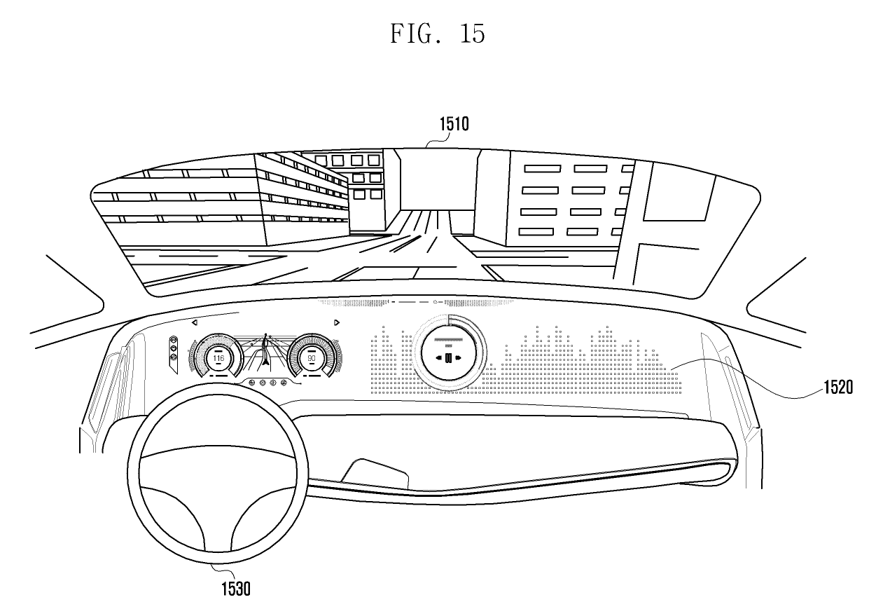

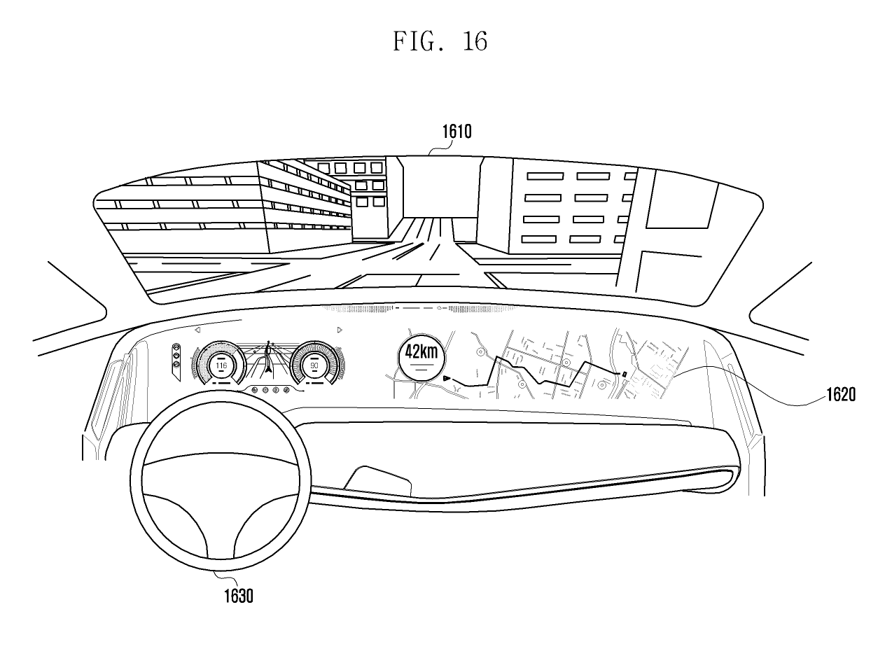

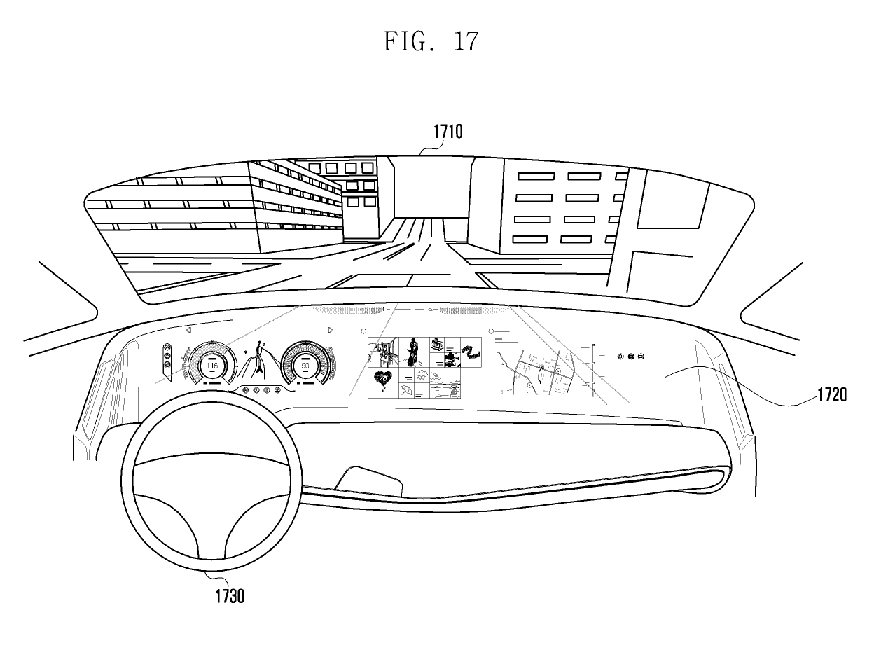

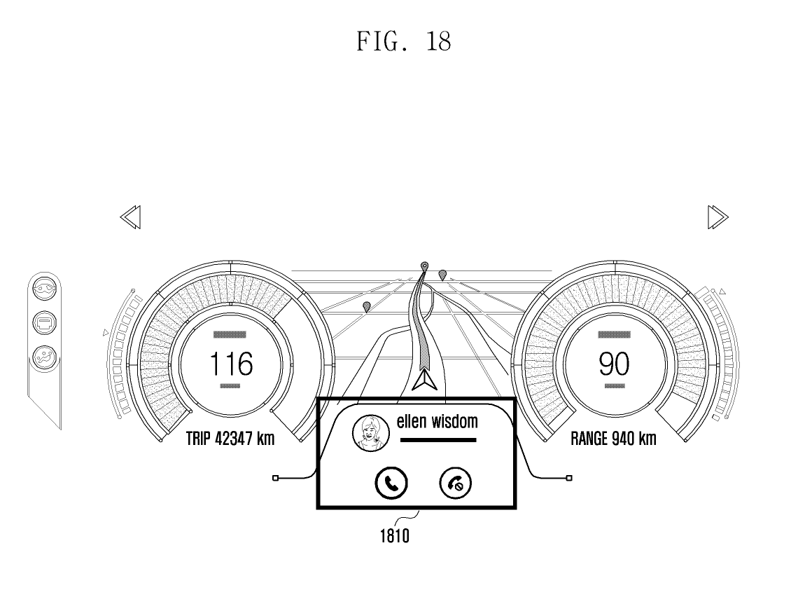

FIG. 12 illustrates a display screen according to an embodiment of the present disclosure. FIG. 13 illustrates a display screen during forward travel according to an embodiment of the present disclosure. FIG. 14 illustrates a display screen during reverse travel according to an embodiment of the present disclosure. FIG. 15 illustrates a display screen during normal traveling according to an embodiment of the present disclosure. FIG. 16 illustrates a display screen during normal traveling according to an embodiment of the present disclosure. FIG. 17 illustrates a display screen during normal traveling according to an embodiment of the present disclosure. FIG. 18 illustrates a quick function according to an embodiment of the present disclosure.

As illustrated in FIG. 12, the control unit 110 may execute a gallery application or a moving image reproduction program, and provide a still image or a moving image as a full screen on the main display. For example, the control unit 110 may enhance the convenience of a user who views the image through the main display 1220 by shifting the position of the steering wheel 130 to a lower height. In the illustrated example, the front portion of the automobile is viewed through the windshield 1210, and the main display 1220 displays an image when the steering wheel 1230 is shifted to a lower stage.

As illustrated in FIG. 13, if the gear of the automobile is shifted into drive (for forward travel), the control unit 110 may display a front screen that is captured by an external camera on the main display. For example, the front screen may include a front state that is not viewed from the driver's viewing angle. The front screen may include a dead-zone image that is hidden by the dashboard and the bonnet at the viewing angle of the driver. According to an embodiment, the control unit 110 may receive in advance an input of user's body information, such as seating height, and predict in advance the driver's viewing angle in accordance with the driver's location and seating height through a mathematical expression. The control unit 110 may enable the front screen that is displayed on the main display 1320 to be successively connected to the front viewing field that can be viewed by the driver through the windshield 1310 in consideration of the predicted driver's viewing angle.

As illustrated in FIG. 14, if the gear of the automobile is shifted to reverse travel, the control unit 110 may display a rear screen that is captured by the external camera on the main display. The rear screen may be the rear state of the automobile captured at an angle of 180°. In FIG. 14, the front of the automobile is viewed through the windshield 1410, and the rear of the automobile is provided through the main display 1420.

As illustrated in FIG. 15, if the gear of the automobile is shifted into drive, the control unit 110 may provide minimum information that is required for driving in a specific region and provide the remaining information in the remaining region of the main display 1520. In FIG. 15, the current speed, the remaining fuel or energy, or a road guide service is displayed only toward the front region of the driver's seat on the main display 1520, and the remaining region indicates that the user interface according to a music reproduction application is provided.

As illustrated in FIG. 16, if the gear of the automobile is shifted into drive, the control unit 110 may provide a user interface according to an application that is required for driving in the entire region of the main display 1620 based on the user input through the main input device. The main display 1620 provides driving information in accordance with the road guide service and a map search service as a full screen under the control of the control unit 110.

As illustrated in FIG. 17, the control unit 110 may provide a front screen that is obtained by capturing an image of the main display 1720 through an external camera and a user interface of the executed application program, which overlap each other, when the automobile is driven. For example, the front screen may include a front state that is not viewed at the viewing angle of the driver. In FIG. 17, the main display 1729 provides the front surface in a semi-transparent manner, and also provides a user interface in accordance with a user application program.

As illustrated in FIG. 18, the control unit 110 may receive a quick function request from a user through the main input device, and provide a user interface in accordance with a specific application on a specific region 1810 of the main display in response to the quick function request. For example, the user interface in accordance with the quick function request may be executed only on the main display that is in front of the driver's seat. In FIG. 18, a function of performing a phone call to an opposite party is performed in accordance with the driver's quick function request on a cluster region 1810 of the main display.

According to another embodiment, the control unit 110 may recognize an external situation through a sensor for sensing an external state related to the automobile, and adaptively control the layout of the main display and the background screen in accordance with the external situation. For example, the control unit 110 may recognize outside weather or a time zone through a rain sensor and/or an external illumination sensor, and increase the esthetic sense of the user by varying the background screen on the main display by the detected weather or time zones. In accordance with the outdoor situation, the control unit 110 not only controls the main display but also provides predetermined sound.

As described above, according to the embodiments of the present disclosure, user convenience can be enhanced during traveling, and a substantial amount of content can be consumed using a large-screen display that is singly connected from the front of the driver's seat to the front of the passenger seat. Since the driver and the passenger can independently use the display and can occasionally share the content, various types of services can be provided in the automobile.

The following are aspects of an automotive control system according to embodiments of the present disclosure, as described above. The automotive control system may include a display located in front of a driver's seat, an input device provided on a steering wheel, and a control unit electrically connected to the display and the input device, wherein the control unit controls the display based on a user input through the input device, and the input device is located on one side and the other side of the steering wheel and is composed of a display including a touch screen.

The control unit may provide a user interface to an entire or partial region of the display based on the user input.

The automotive control system may further include a driver recognition device configured to identify a driver; and a communication module configured to be connected to an external device, wherein the control unit identifies the driver through the driver recognition device, transmits information on the identified driver to the external device through the communication module, receives driver data for the driver from the external device, and provides a user interface based on the received driver data.

The user interface based on the driver data may include at least one of a road guide service to a destination according to a schedule of the driver, a surroundings guide service, and a user interface of at least one application that is preset by the driver.

The control unit may change settings of a display layout and a background screen based on the identified driver information, and provide a user interface included in at least one application that is preset by the driver. The control unit may connect to an application market through the communication module based on the user input, and download and install a specific application that is from the application market in a memory based on a user input for a screen that is provided by the application market.

The automotive control system may further include an auxiliary input device that is provided on at least one of the center of a dashboard, a dashboard in front of a passenger seat, a door handle, an arm rest of a back seat, and a back surface of a head rest provided in the driver's seat or the passenger seat.

The input device may include a first main input device provided on one side of the steering wheel; and a second main input device provided on the other side of the steering wheel.

The control unit may select a region of the display on which the user interface is to be provided in response to a first user input through the first main input device, and execute the application in response to a second user input through the first main input device and provide the user interface on the selected region.

The control unit may control particulars of the user interface that is provided on the selected region in response to a third user input through the second main input device.

The automotive control system may further include a camera configured to photograph front and rear sides of an automobile, wherein the control unit operates to display a front screen that is photographed through the camera on the display if a gear of the automobile is shifted to perform forward travel, and the front screen includes a dead zone image that is hidden by a dashboard and a bonnet from a viewing angle of a driver.

The control unit may set the dead zone image to be successively connected to a front visual field that is viewed at the viewing angle of the driver.

The display may be a single display that is mounted on a dashboard and is extended from a front side of the driver's seat to a front side of a passenger seat.

The automotive control system may further include an auxiliary display that is configured to display an image on an entire or partial region of windshield and is composed of any one of a head-up display, a hologram display, and a transparent display.

Each of the above-discussed elements described in the present disclosure may be formed of one or more components, and names of the corresponding elements may be varied according to the type of an electronic device. In embodiments, the electronic device disclosed herein may be formed of at least one of the above-discussed elements without some elements or with additional other elements. Some of the elements of the electronic device according to embodiments may be integrated into a single entity that still performs the same functions as those of such elements before integrated.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An automotive control system comprising:
a display located in front of a driver's seat of an automobile;
an input device provided on a steering wheel; and
a control unit electrically connected to the display and the input device,
wherein the control unit controls the display based on a user input through the input device, and
wherein the input device is located on one side of the steering wheel and an opposite side of the one side of the steering wheel and is composed of a display including a touch screen.

2. The automotive control system of claim 1, wherein the control unit provides a user interface to an entire or partial region of the display based on the user input.

3. The automotive control system of claim 1, further comprising:
a driver recognition device configured to identify a driver of the automobile; and
a communication module configured to be connected to an external device,
wherein the control unit:
identifies the driver through the driver recognition device, transmits information on the identified driver to the external device through the communication module,
receives driver data for the driver from the external device, and
provides a user interface based on the received driver data.

4. The automotive control system of claim 3, wherein the user interface based on the driver data comprises at least one of a road guide service to a destination according to a schedule of the driver, a surroundings guide service, and a user interface of at least one application that is preset by the driver.

5. The automotive control system of claim 3, wherein the control unit changes settings of a display layout and a background screen based on the identified driver information, and provides a user interface included in at least one application that is preset by the driver.

6. The automotive control system of claim 3, wherein the control unit connects to an application market through the communication module based on the user input, and downloads and installs a specific application that is from the application market in a memory based on a user input for a screen that is provided by the application market.

7. The automotive control system of claim 1, further comprising an auxiliary input device that is provided on at least one of a center of a dashboard, the dashboard in front of a passenger seat, a door handle, an arm rest of a back seat, and a back surface of a head rest provided in the driver's seat or the passenger seat.

8. The automotive control system of claim 1, wherein the input device comprises:
a first main input device provided on the one side of the steering wheel; and
a second main input device provided on the opposite side of the steering wheel.

9. The automotive control system of claim 8, wherein the control unit selects a region of the display on which the user interface is to be provided in response to a first user input through the first main input device, and executes the application in response to a second user input through the first main input device and provides the user interface on the selected region.

10. The automotive control system of claim 9, wherein the control unit controls functions of the user interface that is provided on the selected region in response to a third user input through the second main input device.

11. The automotive control system of claim 1, further comprising at least one camera configured to photograph front and rear sides of the automobile,
wherein the control unit operates to display a front screen that is photographed through the at least one camera on the display if a gear of the automobile is shifted to perform forward travel, and
wherein the front screen includes a dead zone image that is hidden from a viewing angle of a driver by a dashboard and a bonnet.

12. The automotive control system of claim 11, wherein the control unit sets the dead zone image to be successively connected to a front visual field that is viewed at the viewing angle of the driver.

13. The automotive control system of claim 1, wherein the display is a single display that is mounted on a dashboard, and is extended from a front side of the driver's seat to a front side of a passenger seat.

14. The automotive control system of claim 1, further comprising an auxiliary display that is configured to display an image on an entire or partial region of a windshield and is composed of any one of a head-up display, a hologram display, and a transparent display.

15. A method for operating an automotive control system having a display located in front of a driver's seat, comprising:
receiving a user input through an input device provided on a steering wheel of an automobile; and
controlling a display that is located in front of the driver's seat based on the user input,
wherein the input device is located on one side of a steering wheel and on an opposite side of the one side of the steering wheel and is composed of a display including a touch screen.

16. The method of claim 15, further comprising:
identifying a driver through a driver recognition device;
transmitting the identified driver information to an external device through a communication module;
receiving driver data for the driver from the external device; and
providing a user interface based on the received driver data through the display.

17. The method of claim 16, wherein the user interface based on the driver data comprises at least one of a road guide service to a destination according to a schedule of the driver, a surroundings guide service, and a user interface of at least one application that is preset by the driver.

18. The method of claim 16, further comprising:
changing settings of a display layout and a background screen based on the identified driver information; and
providing the user interface included in at least one application that is preset by the driver.

19. The method of claim 15, further comprising:
connecting to an application market of the external device through a communication module based on the user input, and
downloading and installing an application that is from the application market in a memory based on a user input for a screen that is provided by the application market.

20. The method of claim 15, further comprising:
receiving a first user input through a first main input device provided on the one side of the steering wheel;
selecting a region of the display on which the user interface is to be provided in response to the first user input; and
executing the application in response to a second user input through the first main input device and providing the user interface on the selected region.

21. The method of claim 20, further comprising:
receiving a third user input through a second main input device provided on the opposite side of the steering wheel; and
controlling functions of the user interface that is provided on the selected region in response to the third user input.

22. The method of claim 15, further comprising displaying a front screen through the display if a gear of the automobile is shifted to perform forward travel,
wherein the front screen includes a dead zone image that is hidden from a viewing angle of a driver by a dashboard and a bonnet.

23. The method of claim 22, further comprising setting the dead zone image to be successively connected to a front visual field that is viewed at the viewing angle of the driver.

24. A non-transitory computer readable recording medium having recorded thereon instructions that cause at least one control unit to perform a method for operating an automotive control system having a display located in front of a driver's seat, comprising:
receiving a user input through an input device provided on a steering wheel of an automobile; and
controlling a display that is located in front of the driver's seat based on the user input,
wherein the input device is located on one side of a steering wheel and on an opposite side of the one side of the steering wheel and is composed of a display including a touch screen.
